(19) United States
(12) Patent Application Publication
(10) Pub. No.: US 2026/0291776 A1
(43) Pub. Date: Sep. 24, 2026

(54) MANAGEMENT DEVICE, VEHICLE COMMUNICATION MANAGEMENT METHOD, AND VEHICLE COMMUNICATION MANAGEMENT PROGRAM

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventors: Yoshio ITO, Osaka-Shi, Osaka (JP); Tatsuya IZUMI, Osaka-shi, Osaka (JP); Hideyuki TANAKA, Osaka-shi, Osaka (JP); Yusuke YAMAMOTO, Osaka-shi, Osaka (JP); Ryo YAMANE, Osaka-shi, Osaka (JP); Kenta OGATA, Osaka-Shi, Osaka (JP); Yoshitaka KIKUCHI, Yokkaichi-Shi, Mie (JP); Darmawan GO, Yokkaichi-Shi, Mie (JP); Hirofumi URAYAMA, Yokkaichi-shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/993,773

(22) PCT Filed: Jun. 7, 2023
(86) PCT No.: PCT/JP2023/021147

§ 371 Date: Jan. 13, 2025

(30) Foreign Application Priority Data
Jul. 15, 2022 (JP) 2022-114250

(51) Int. Cl. H04L 12/46; B60R 16/023

(52) U.S. Cl. CPC H04L 12/46; B60R 16/023

(57) ABSTRACT

A device according to an aspect of the present disclosure is a management device for use in an in-vehicle network installed in a vehicle, the management device including: an importance level determination unit configured to determine an importance level of a frame to be relayed by a relay device that performs relay processing for relaying a frame transmitted and received between a plurality of functional units in the in-vehicle network and is a target of setting change; and an executability determination unit configured to determine whether or not to perform the setting change, based on a determination result of the importance level determination unit.

### CROSS-REFERENCE TO RELATED APPLICATIONS

This application is the U.S. national stage of PCT/JP2023/021147 filed on Jun. 7, 2023, which claims priority of Japanese Patent Application No. JP 2022-114250 filed on Jul. 15, 2022, the contents of which are incorporated herein.

### TECHNICAL FIELD

The present disclosure relates to a management device, a vehicle communication management method, and a vehicle communication management program.

### BACKGROUND

Techniques for performing setting change of the configuration of an in-vehicle network have been developed. For example, WO 2020/145334A discloses a technique as described below. Specifically, a vehicle control device controls a plurality of relays based on a control scenario in which the state of a vehicle in which a vehicle network including a plurality of relays is constructed, is associated with a control content set for each of the plurality of relays.

When the settings of an in-vehicle network are to be dynamically changed as in the above-described WO 2020/145334A, the change of settings may affect communication in the in-vehicle network.

The present disclosure has been made in order to solve the above problems, and an object thereof is to provide a management device, a vehicle communication management method, and a vehicle communication management program capable of changing settings of an in-vehicle network while maintaining stable operation of the in-vehicle network.

### SUMMARY

A management device according to the present disclosure is a management device for use in an in-vehicle network installed in a vehicle, the management device including: an importance level determination unit configured to determine an importance level of a frame to be relayed by a relay device that performs relay processing for relaying a frame transmitted and received between a plurality of functional units in the in-vehicle network and is a target of setting change; and an executability determination unit configured to determine whether or not to perform the setting change, based on a determination result of the importance level determination unit.

An aspect of the present disclosure can be implemented as a semiconductor integrated circuit that implements some or the entirety of a management device, and as a system that includes the management device.

### Advantageous Effects

According to the present disclosure, settings of an in-vehicle network can be changed while maintaining stable operation of the in-vehicle network.

### BRIEF DESCRIPTION OF DRAWINGS

FIG. 1 is a diagram showing a configuration of an in-vehicle communication system according to an embodiment of the present disclosure.

FIG. 2 is a diagram showing a configuration of a relay device according to the embodiment of the present disclosure.

FIG. 3 is a diagram showing an example of messages relayed in the in-vehicle communication system according to the embodiment of the present disclosure.

FIG. 4 is a diagram showing an example of a message importance level table in a relay device according to the embodiment of the present disclosure.

FIG. 5 is a diagram showing a configuration of a variation 2 of the relay device according to the embodiment of the present disclosure.

FIG. 6 is a flowchart defining an example of an operation procedure performed by the relay device according to the embodiment of the present disclosure when performing network setting change.

FIG. 7 is a flowchart defining an example of an operation procedure performed by the variation 2 of the relay device according to the embodiment of the present disclosure when performing network setting change.

FIG. 8 is a diagram showing an example of a sequence of performing network setting change in the in-vehicle communication system according to the embodiment of the present disclosure.

FIG. 9 is a diagram showing an example of a sequence of performing network setting change in the in-vehicle communication system according to the embodiment of the present disclosure.

### DETAILED DESCRIPTION OF PREFERRED EMBODIMENTS

Embodiments of the present disclosure will be listed and described below in detail.

In a first aspect, a management device according to an embodiment of the present disclosure is a management device for use in an in-vehicle network installed in a vehicle, the management device including: an importance level determination unit configured to determine an importance level of a frame to be relayed by a relay device that performs relay processing for relaying a frame transmitted and received between a plurality of functional units in the in-vehicle network and is a target of setting change; and an executability determination unit configured to determine whether or not to perform the setting change, based on a determination result of the importance level determination unit.

In this manner, with the configuration in which it is determined whether or not the setting change of the relay device can be executed in consideration of the importance level of the frame to be relayed in the in-vehicle network, for example, it is possible to prevent a message exchanged between the ECUs of the control system from being delayed or discarded due to the setting change, and thus it is possible to reduce the possibility that the communication of the control system is affected, which affects the traveling of the vehicle. Therefore, it is possible to change the settings of the in-vehicle network while maintaining stable operation in the in-vehicle network.

In a second aspect according to the first aspect, the management device may further include: a generation unit configured to generate setting information of a new network, based on device information acquired from the plurality of functional units, and thereby determine the relay device to be a target of a setting change for performing communication in the new network, and notifying the determined relay device of a setting content, wherein, when the executability determination unit determines not to perform the setting change of at least one of the plurality of relay devices, the generation unit does not notify the at least one of the plurality of relay devices of the setting content.

With this configuration, when a plurality of relay devices are provided in the in-vehicle network and the setting change target is the plurality of relay devices, it is possible to prevent a case where a relay device in which the setting change has not been reflected and a relay device in which the setting change has been reflected are both present, and inconsistency occurs in the entire system.

In a third aspect according to the first or the second aspect, the management apparatus may further include: a storage unit configured to store correspondence information indicating a correspondence relationship between identification information of the relay device and an importance level of a frame to be relayed by the relay device, wherein the importance level determination unit determines the importance level based on the correspondence information.

With this configuration, it is possible to determine the importance level of the frame using the correspondence information by simple processing.

In a fourth aspect according to any one of the first through the third aspects, the management device may further include: a relay state determination unit configured to determine whether or not the relay device in the in-vehicle network is in a state of relaying a frame of a specific importance level, wherein the executability determination unit determines whether or not to perform the setting change, based on a determination result of the importance level determination unit and a determination result of the relay state determination unit.

With this configuration, even in a case where a relay device that relays a frame whose importance level is high is a setting change target, it is possible for the setting change to be held and executed at an appropriate timing, and thus it is possible to more reliably execute the setting change of the in-vehicle network.

In a fifth aspect according to the fourth aspect, the management device may further include a vehicle state acquisition unit configured to acquire vehicle state information related to a state of the vehicle, wherein the relay state determination unit determines whether or not the relay device in the in-vehicle network is in a state of relaying a frame of the specific importance level, based on the vehicle state information acquired by the vehicle state acquisition unit.

With this configuration, it is possible to execute the held setting change at an appropriate timing such as during stop of the vehicle, at which it is highly possible that a frame whose importance level is high is not being relayed.

In a sixth aspect according to the fourth aspect, the relay state determination unit may make an inquiry to a specific functional unit as to whether or not the frame of the specific importance level is being transmitted.

With such a configuration, it is possible to more reliably grasp a state where a frame whose importance level is high is not being relayed, and thus the held setting change can be executed at an appropriate timing.

In a seventh aspect according to any one of the first through the sixth aspects, the management apparatus may further include: a device information acquisition unit configured to acquire device information of the functional units, wherein the importance level determination unit determines the importance level, based on the device information acquired by the device information acquisition unit.

With this configuration, it is possible to more accurately determine the importance level of the frame, using the information of the functional unit in the in-vehicle network.

In an eighth aspect, a vehicle communication management method according to the embodiment of the present disclosure is a vehicle communication management method in a management device for use in an in-vehicle network installed in a vehicle, the vehicle communication management method including: a step of determining an importance level of a frame to be relayed by a relay device that performs relay processing for relaying a frame transmitted and received between a plurality of functional units in the in-vehicle network and is a target of a setting change; and a step of determining whether or not to perform the setting change, based on a determination result of the importance level.

As described above, with the configuration in which it is determined whether or not the setting change of the relay device can be executed in consideration of the importance level of the frame to be relayed in the in-vehicle network, for example, it is possible to prevent the message exchanged between the ECUs of the control system from being delayed or discarded due to the setting change and reduce the possibility that the communication of the control system is affected, which affects the traveling of the vehicle. Therefore, it is possible to change the setting of the in-vehicle network while maintaining stable operation of the in-vehicle network.

In a ninth aspect, a vehicle communication management program according to the embodiment of the present disclosure is a vehicle communication management program to be used in a management device for use in an in-vehicle network installed in a vehicle, the vehicle communication management program causing a computer to function as: an importance level determination unit configured to determine an importance level of a frame to be relayed by a relay device that performs relay processing relaying a frame transmitted and received between a plurality of functional units in the in-vehicle network and is a target of a setting change; and an executability determination unit configured to determine whether or not to perform the setting change, based on a determination result of the importance level determination unit.

As described above, with the configuration in which executability of the setting change of the relay device is determined in consideration of the importance level of the frame to be relayed in the in-vehicle network, for example, it is possible to prevent the message exchanged between the ECUs of the control system from being delayed or discarded due to the setting change, so that it is possible to reduce the possibility that the communication of the control system is affected, which affects the traveling of the vehicle. Therefore, it is possible to change the settings of the in-vehicle network while maintaining stable operation of the in-vehicle network.

Hereinafter, embodiments of the present disclosure will be described using the drawings. Note that the same reference numerals are given to the same or corresponding portions in the drawings, and description thereof will not be repeated. In addition, at least some of the embodiments described below can be combined as desired.

### In-Vehicle Communication System

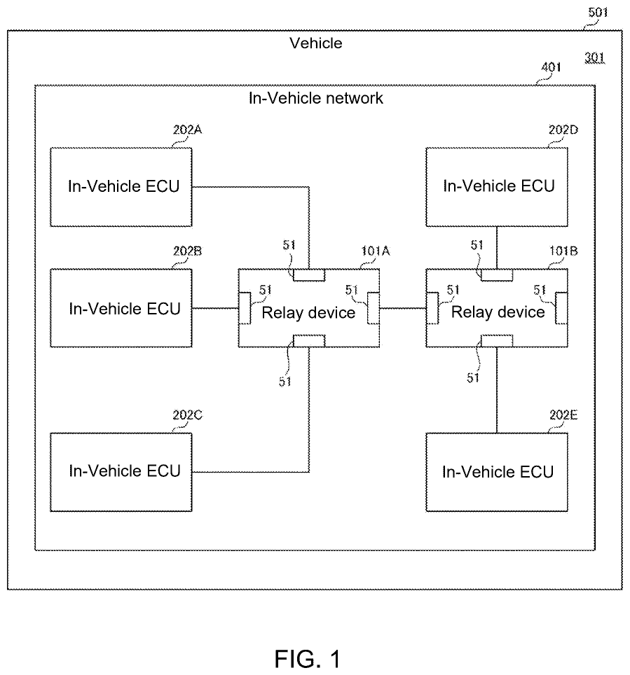

FIG. 1 is a diagram showing a configuration of an in-vehicle communication system according to an embodiment of the present disclosure. Referring to FIG. 1, an in-vehicle communication system 301 includes a plurality of in-vehicle Electric Control Units (ECUs) 202 and one or more relay devices 101.

In an example shown in FIG. 1, the in-vehicle communication system 301 includes in-vehicle ECUs 202A, 202B, 202C, 202D, and 202E, which are in-vehicle ECUs 202, and relay devices 101A and 101B, which are relay devices 101. The in-vehicle communication system 301 is mounted in a vehicle 501. The in-vehicle ECUs 202 and the relay devices 101 constitute an in-vehicle network 401. The in-vehicle ECUs 202 are an example of a functional unit. The relay device 101A includes a management device according to the embodiment of the present disclosure.

The in-vehicle communication system 301 is not limited to the configuration including the five in-vehicle ECUs 202, and may be any configuration as long as it includes a plurality of in-vehicle ECUs 202. Further, the in-vehicle communication system 301 is not limited to the configuration including the two relay devices 101, and may be configured to include one or three or more relay devices 101.

In the in-vehicle network 401, the in-vehicle ECUs 202 are connected to relay devices 101 via, for example, Ethernet (registered trademark) cables.

More specifically, the relay device 101 includes a plurality of communication ports 51. The communication ports 51 are, for example, terminals connectable to Ethernet cables. The relay devices 101 and the in-vehicle ECUs 202 are each connected to other relay devices 101 or other in-vehicle ECUs 202 via the communication ports 51 and Ethernet cables.

The relay device 101 is used in an in-vehicle network 401 that includes the plurality of in-vehicle ECUs 202. The relay device 101 is, for example, a gateway device, and is capable of relaying data between the plurality of in-vehicle ECUs 202 connected thereto. The relay device 101 can perform relay processing according to, for example, a layer 2 and a layer 3 higher than the layer 2.

More specifically, the relay device 101 performs relay processing of a frame exchanged between the in-vehicle ECUs 202 connected via the Ethernet cables, for example, in conformity with Ethernet communication standards.

Note that the in-vehicle communication system 301 is not limited to a configuration in which the frames are relayed in conformity with Ethernet communication standards, and may be a configuration in which frames are relayed in conformity with a communication standard such as Controller Area Network (CAN), CAN with Flexible Data Rate (CAN FD), FlexRay (registered trademark), Media Oriented Systems Transport (MOST) (registered trademark), and Local Interconnect Network (LIN).

The in-vehicle ECUs 202 are, for example, an autonomous driving ECU, an engine ECU, a sensor, a navigation device, a human machine interface, a camera, or the like.

Each relay device 101 and each in-vehicle ECU 202 generate a frame including various types of information described later, and transmit the frame to another in-vehicle ECU 202 or the relay device 101.

As will be described later, when a predetermined event occurs, the relay device 101A performs change of settings of the in-vehicle network 401 (hereinafter, also referred to as a “network setting change”). Hereinafter, the in-vehicle network 401 to which the network setting change has been reflected is also referred to as a “new network”.

### Relay Device 101A

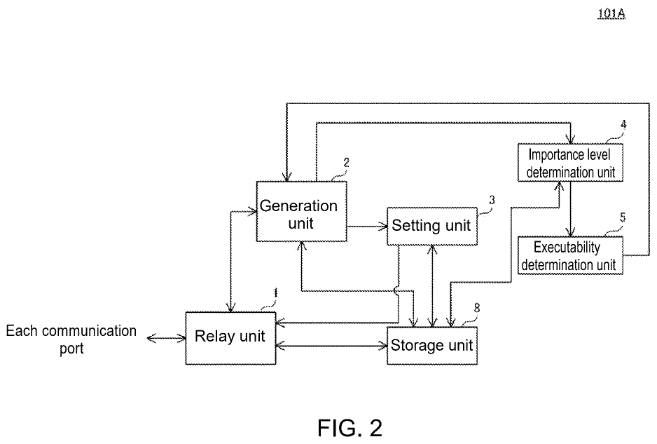

FIG. 2 is a diagram illustrating the configuration of a relay device according to the embodiment of the present disclosure. FIG. 2 shows the configuration of the relay device 101A shown in FIG. 1.

Referring to FIG. 2, the relay device 101A includes a relay unit 1, a generation unit 2, a setting unit 3, an importance level determination unit 4, an executability determination unit 5, and a storage unit 8. Some or all of the relay unit 1, the generation unit 2, the setting unit 3, the importance level determination unit 4, and the executability determination unit 5 are implemented by, for example, a processing circuit including one or more processors. The storage unit 8 is, for example, a nonvolatile memory included in the processing circuit.

The relay unit 1 performs relay processing for relaying a frame transmitted and received between the in-vehicle ECUs 202. More specifically, upon receipt of a frame from one in-vehicle ECU 202 or the relay device 101B, the relay unit 1 transmits the received frame to the in-vehicle ECU 202 or the relay device 101B serving as the transmission destination.

The generation unit 2, which serves as a device information acquisition unit, acquires device information including information related to a network configuration of a layer lower than the application layer, for example, of each of the plurality of functional units.

More specifically, when a predetermined event that triggers a network setting change occurs, the generation unit 2 acquires device information of each functional unit such as each in-vehicle ECU 202. The generation unit 2 may be configured to acquire the device information of the relay devices 101A and 101B in addition to the device information of each functional unit.

The event is, for example, a case where a user performs a predetermined operation on an in-vehicle ECU 202 that is a navigation device. The event may be a case where a functional unit is newly added to the in-vehicle network 401, specifically, a case where an in-vehicle ECU 202 is added to the in-vehicle network 401, or a case where an application is newly installed in an existing in-vehicle ECU 202 in the in-vehicle network 401. As described above, the functional unit may be hardware or software.

For example, the generation unit 2 acquires, as the device information, information by which at least one of the following three can be recognized, namely, information by which specifications of hardware devices such as the in-vehicle ECU 202 and the relay device 101 in the new network and a topology of the new network can be recognized, a restriction on arrangement of an application in a hardware device in the new network, and a restriction on a communication scheme in the new network.

The generation unit 2 acquires, as the information by which the specification of the hardware device and the topology of the new network can be recognized, for example, at least one type of information among information regarding an identifier, a name, a device type indicating a sensor type or the like, a memory size, the number of physical ports provided for each communication protocol, an identifier of a physical port, a power supply configuration, power consumption, an ID of a virtual local area network (VLAN), a subnet address, and information regarding a functional domain of the hardware device, information regarding a specification of a CPU or a graphics processing unit (GPU) mounted on the hardware device, a connection relationship between the hardware devices, information regarding a bandwidth of communication between the hardware devices, and information regarding a specification of the relay device 101.

The generation unit 2 acquires, for example, at least one type of information among information related to an operation speed necessary for execution of the application in the in-vehicle ECU 202, a memory use amount, restrictions of operating system (OS) environments, and restrictions of communication protocols such as a transmission control protocol (TCP) and a user datagram protocol (UDP), as the information by which the restrictions related to the arrangement of the application in the hardware device can be recognized.

The generation unit 2 acquires at least one type of information among a communication size, a communication frequency, necessity of burst transmission, an allowable delay time, an allowable loss amount, a required security level, an operation timing, a communication type indicating, for example, periodic communication or irregular communication, an identifier of an application serving as a communication partner, a messaging scheme indicating a request response type, a publication subscription type, or the like, and information regarding a priority of communication by an application, of an application in an in-vehicle ECU 202, as information by which a restriction of a communication scheme in a new network can be recognized.

For example, the generation unit 2 specifies one or a plurality of types of device information necessary for generating the setting information of the new network, among the types of device information as described above.

The generation unit 2 transmits an information request notification indicating that the specified type of device information is to be transmitted to each functional unit and the relay device 101B, via the relay unit 1, for example.

As a response to the information request notice received from the generation unit 2, each of the functional units and the relay device 101B transmit, for example, its own device information of the type specified in the information request notice to the generation unit 2.

Further, for example, the generation unit 2 references the storage unit 8 and acquires the device information of the relay device 101A of the specified type from the storage unit 8.

The generation unit 2 generates setting information of the new network based on the acquired device information.

More specifically, by generating the setting information, the generation unit 2 determines one or a plurality of relay devices 101 (hereinafter, also referred to as target relay devices) whose settings are to be changed for performing communication in the new network. Then, the generation unit 2 notifies the target relay devices of the setting content based on the generated setting information.

For example, based on the acquired device information, the generation unit 2 generates setting information including setting contents of the target relay devices for performing communication by each functional unit and the relay devices 101A and 101B in the new network, such as filtering, a communication bandwidth, and VLAN setting in the relay device 101. The generation unit 2 notifies the importance level determination unit 4 of the identification information of the target relay devices.

On the other hand, when there is no relay device 101 whose settings need to be changed in the new network, the generation unit 2 does not notify the importance level determination unit 4 of the identification information.

The importance level determination unit 4 determines the importance levels of the frames relayed by the target relay devices notified from the generation unit 2.

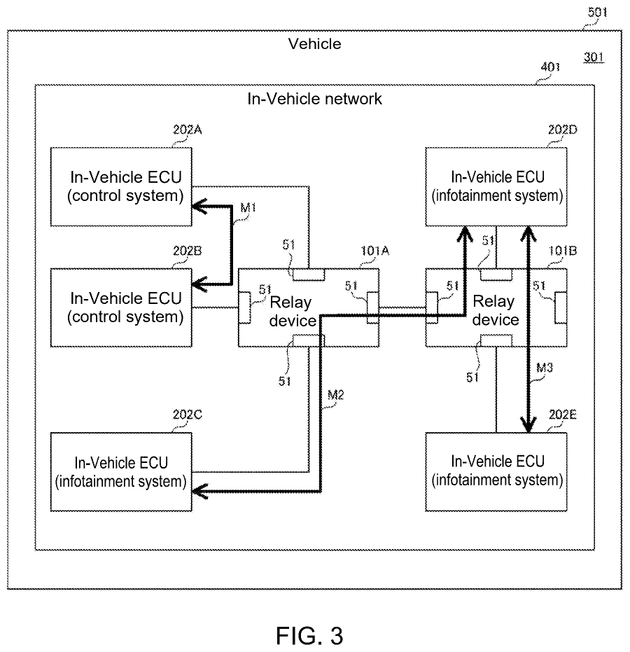

FIG. 3 is a diagram illustrating an example of messages relayed in the in-vehicle communication system according to the embodiment of the present disclosure.

Referring to FIG. 3, the in-vehicle ECUs 202A and 202B are, for example, ECUs of a control system, such as an autonomous driving ECU, an engine ECU, a sensor, and a camera, which exchange information regarding traveling of vehicles 501. The in-vehicle ECUs 202C, 202D, and 202E are, for example, ECUs of an infotainment system such as a navigation device.

In the in-vehicle communication system 301, a frame including a message M1 exchanged between the in-vehicle ECUs 202A and 202B is relayed by the relay device 101A, a frame including a message M2 exchanged between the in-vehicle ECUs 202C and 202D relayed by the relay devices 101A and 101B, and a frame including a message M3 exchanged between the in-vehicle ECUs 202D and 202E is relayed by the relay device 101B.

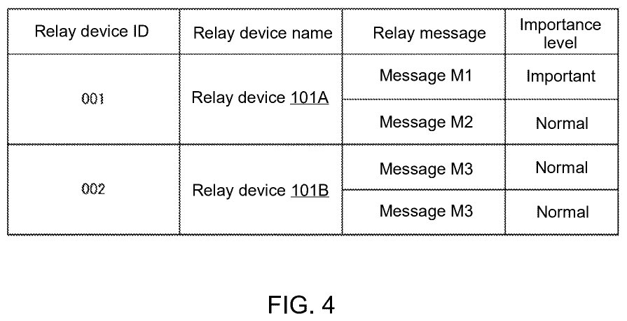

FIG. 4 is a diagram showing an example of the message importance level table of the relay devices according to the embodiment of the present disclosure.

The storage unit 8 stores correspondence information indicating a correspondence relationship between the identification information of the relay devices 101 and each importance level of one or a plurality of types of frames relayed by the relay devices 101.

Specifically, with reference to FIG. 4, the message importance level table, which is an example of the correspondence information, indicates the correspondence relationship among the IDs of the relay devices 101, the relay device names, the types of the messages to be relayed, and the importance levels of the messages.

In the message importance level table, the relay device 101A whose ID is “001” relays the message M1 whose importance level is “important” and the message M2 whose importance level is “normal”. The relay device 101B whose ID is “002” relays the messages M2 and M3 whose importance levels are “normal”.

In this manner, in the in-vehicle communication system 301, since the message exchanged between the ECUs of the control system is a message that affects the traveling of the vehicle 501, the importance level is set to “important”. On the other hand, the message exchanged between the ECUs of the infotainment system is a message having a low possibility of affecting the traveling of the vehicle 501, and thus the importance level is set to “normal”.

The importance level determination unit 4 determines the importance level based on the correspondence information. More specifically, the importance level determination unit 4 refers to the message importance level table, and when the ID of the target relay device notified from the generation unit 2 is “001”, the importance level determination unit 4 notifies the executability determination unit 5 that the importance level of the frame to be relayed by the target relay device is “important”. On the other hand, the importance level determination unit 4 refers to the message importance level table, and when the ID of the target relay device notified from the generation unit 2 is “002”, the importance level determination unit 4 notifies the executability determination unit 5 that the importance level of the frame to be relayed by the target relay device is “normal”.

Note that the message importance levels that may be indicated by the message importance level table are not limited to “important” and “normal”, and three or more types of importance levels may be indicated. In this case, the importance level determination unit 4 comprehensively determines the importance levels of each message to be relayed by the relay devices 101, and notifies the executability determination unit 5 of the determination result.

Referring to FIG. 2 again, the executability determination unit 5 determines whether the setting change of the target relay device is to be performed, based on the determination result of the importance level determination unit 4.

More specifically, when the executability determination unit 5 is notified of the determination result “important” from the importance level determination unit 4, the executability determination unit 5 notifies the generation unit 2 of “not executable” of the setting change of the target relay device. On the other hand, when the executability determination unit 5 is notified of the determination result “normal” from the importance level determination unit 4, the executability determination unit 5 notifies the generation unit 2 that the setting change of the target relay device is “executable”.

That is, when the message M1 whose importance level is “important” is delayed or discarded due to the setting change, for example, during the period from when the relay device 101A starts setting change until when it completes the setting change, it may affect the communication of the control system and the traveling of the vehicle 501. For this reason, the executability determination unit 5 determines that the setting change is not to be performed.

On the other hand, when the setting change of the relay device 101B is performed, even if the messages M2 and M3 whose importance levels are “normal” are delayed or discarded due to the setting change, it is unlikely to affect communication in the control system. For this reason, the executability determination unit 5 determines that the settings change can be performed.

When notified of “not executable” by the executability determination unit 5, the generation unit 2 cancels or suspends the setting change of the target relay device, that is, notifying the target relay device of the setting contents.

On the other hand, when notified of “executable” by the execution determination unit 5, the generation unit 2 notifies, based on the generated setting information, at least one of the relay devices 101A and 101B whose settings need to be changed, of the setting content for performing communication in the new network.

In addition, for example, if a plurality of relay devices 101 are determined as the targets of the setting change, when the executability determination unit 5 determines that the setting change of at least one of the plurality of relay devices 101 is not to be performed, the generation unit 2 does not notify the plurality of relay devices 101 of the setting content.

More specifically, if notified of the IDs of both the relay devices 101A and 101B from the generation unit 2, the importance level determination unit 4 notifies the executability determination unit 5 that the importance level of the frame to be relayed by the relay device 101A is “important” and the importance level of the frame to be relayed by the relay device 101B is “normal”.

Since the executability determination unit 5 is notified of the determination result that the relay device 101A is “important” from the importance level determination unit 4, the executability determination unit 5 notifies the generation unit 2 that the setting change of the target relay device is “not executable”.

When the generation unit 2 notifies the relay device 101A of the setting content, the generation unit 2 notifies the setting unit 3 of the setting content. When notifying the relay device 101B of the setting content, the generation unit 2 transmits a frame including the setting content to the relay device 101B via the relay unit 1.

When notified of the setting content from the generation unit 2, the setting unit 3 and the relay device 101B in the relay device 101A executes various setting changes according to the notified setting content.

Note that the generation unit 2 may be configured to generate setting information further including the setting content of the functional unit and notify the functional unit of the setting content for performing communication in the new network in addition to the relay device 101, based on the setting information.

The functional units and the relay devices 101A and 101B in the new network communicate with each other in accordance with the changed setting contents.

### Variation 1

A configuration is also possible where the storage unit 8 does not store the message importance level table. In this case, the importance level determination unit 4 may be configured to determine the importance level of the frame to be relayed by the target relay device based on the device information acquired by the generation unit 2.

More specifically, the generation unit 2 notifies the importance level determination unit 4 of the identification information of the target relay device, and outputs the acquired device information to the importance level determination unit 4.

The importance level determination unit 4 determines whether the importance of the frame to be relayed by the target relay device is “important” or “normal”, based on the information related to the application in the in-vehicle ECU 202, the specifications of the relay device 101, or the like, that are indicated by the device information received from the generation unit 2.

### Variation 2

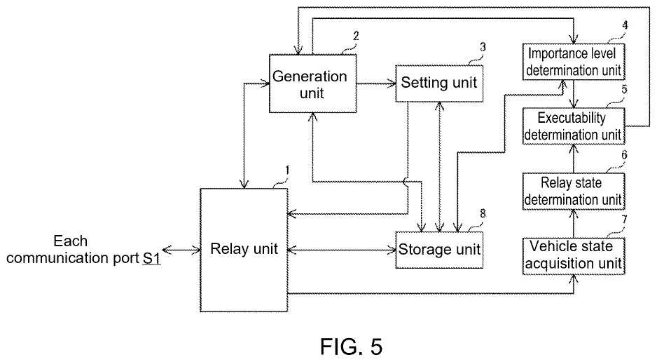

FIG. 5 is a diagram showing the configuration of a variation 2 of the relay device according to the embodiment of the present disclosure. FIG. 5 shows the configuration of a variation of the relay device 101A shown in FIG. 1.

Referring to FIG. 5, the variation 2 of the relay device 101A further includes a relay state determination unit 6 and a vehicle state acquisition unit 7 in comparison to the relay device 101A shown in FIG. 2. Some or all of the relay unit 1, the generation unit 2, the setting unit 3, the importance level determination unit 4, the executability determination unit 5, the relay state determination unit 6, and the vehicle state acquisition unit 7 are implemented by, for example, a processing circuit including one or more processors. The storage unit 8 is, for example, a nonvolatile memory included in the processing circuit.

The relay state determination unit 6 determines whether or not the relay device 101 in the in-vehicle network 401 is in a state of relaying a frame of a specific importance level.

The executability determination unit 5 determines whether or not to perform the setting change of the target relay device, based on the determination result of the importance level determination unit 4 and the determination result of the relay state determination unit 6.

For example, the vehicle state acquisition unit 7 acquires vehicle state information about the state of the vehicle 501 and outputs the vehicle state information to the relay state determination unit 6. The vehicle state information indicates a state related to the traveling of the vehicle 501, a state of a battery, a state of an air conditioner, a state of a driver, and the like.

The relay state determination unit 6 determines whether or not the relay device 101 in the in-vehicle network 401 is in a state of relaying a frame of a specific importance level, based on the vehicle state information acquired by the vehicle state acquisition unit.

Specifically, the vehicle state acquisition unit receives, via the relay unit 1, vehicle state information related to the state of the vehicle 501, which is periodically or irregularly transmitted from a specific in-vehicle ECU 202, and outputs the vehicle state information to the relay state determination unit 6. In this embodiment, the vehicle state information indicates that the vehicle 501 is traveling or the vehicle 501 is stopped.

When the relay state determination unit 6 receives the vehicle state information indicating that the vehicle 501 is traveling from the vehicle state acquisition unit, the relay state determination unit 6 notifies the executability determination unit 5 that the relay state is a relay state 1 in which the relay device 101 in the in-vehicle network 401 relays the frame whose importance level is “important”. On the other hand, when the relay state determination unit 6 receives the vehicle state information indicating that the vehicle 501 is stopped, from the vehicle state acquisition unit, the relay state determination unit 6 notifies the executability determination unit 5 that the relay state is the relay state 2 in which the relay device 101 in the in-vehicle network 401 does not relay the frame whose importance level is “important”.

When notified of the determination result “important” from the importance level determination unit 4 and notified of the relay state 1 from the relay state determination unit 6, the executability determination unit 5 notifies the generation unit 2 that the setting change of the target relay device is “not executable”. On the other hand, in a case where the executability determination unit 5 is notified of the determination result “normal” from the importance level determination unit 4, or in a case where the executability determination unit 5 is notified of the relay state 2 from the relay state determination unit 6, the executability determination unit 5 notifies the generation unit 2 that the setting change of the target relay device is “executable”.

The relay state determination unit 6 is not limited to the configuration in which the relay state is determined using the vehicle state information, and may be configured to inquire of a specific functional unit whether or not a frame of a specific importance level is being transmitted.

In a specific example, the relay state determination unit 6 transmits a transmission state query to the in-vehicle ECU 202 of the control system via the relay unit 1, and determines the relay state based on a transmission state response from the in-vehicle ECU 202 indicating whether or not the message M1 is being transmitted. In such a configuration, for example, when the in-vehicle ECU 202 transmits the transmission state response indicating that the message M1 is not being transmitted to the relay device 101A, the in-vehicle ECU 202 suspends the transmission of the message M1 until a predetermined time elapses from the transmission of the transmission state response.

### Operation Flow

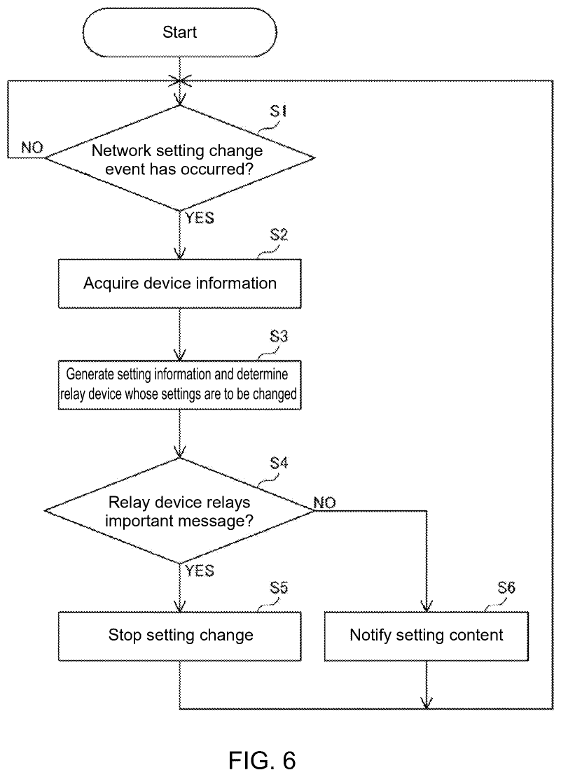

FIG. 6 is a flowchart defining an example of an operation procedure when the relay device according to the embodiment of the present disclosure performs the network setting change.

Referring to FIG. 6, first, when a predetermined event that triggers the network setting change occurs (YES in step S1), the relay device 101A acquires, for example, device information of the functional units and relay devices 101 (step S2).

Next, the relay device 101A determines the target relay device by generating setting information based on the acquired device information (step S3).

Next, when the importance level of the frame to be relayed by the target relay device is “important” (YES in step S4), the relay device 101A stops the setting change of the target relay device (step S5).

On the other hand, when the importance level of the frame to be relayed by the target relay device is “normal” (NO in step S4), the relay device 101A notifies the target relay device of the setting content (step S6).

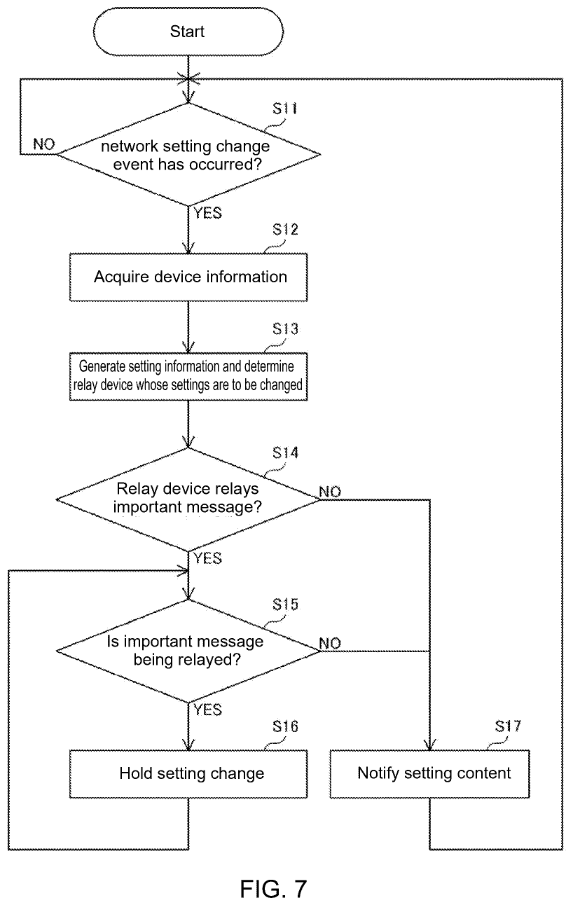

FIG. 7 is a flowchart defining an example of an operation procedure when variation 2 of the relay device according to the embodiment of the present disclosure performs a network setting change.

Referring to FIG. 7, the processing from step S11 to step S13 is the same as that from step S1 to step S3 in FIG. 6.

Next, when the importance level of the frame to be relayed by the target relay device is “normal” (NO in step S14), the relay device 101A notifies the target relay device of the setting content (step S17).

On the other hand, if the importance level of the frame to be relayed by the target relay device is “important” (YES in step S4) and the relay state is the relay state 1 in which the relay device 101 in the in-vehicle network 401 relays the frame whose importance level is “important” (YES in step S15), the relay device 101A suspends the setting change of the target relay device (step S16), and if the state transitions to the relay state 2 in which the frame is not relayed (NO in step S15), the relay device 101A notifies the target relay device of the setting content (step S17).

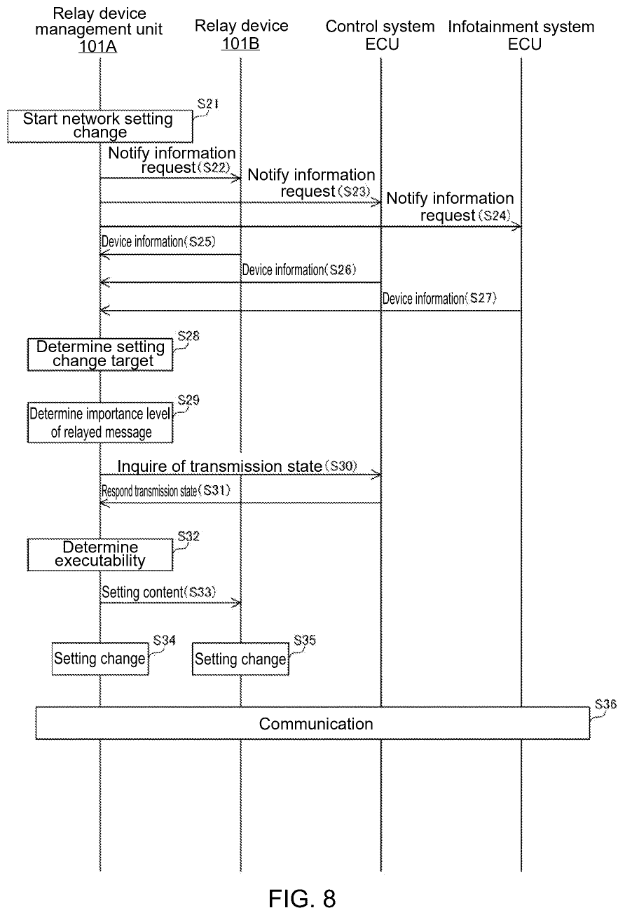

FIG. 8 is a diagram illustrating an example of a sequence of a network setting change in the in-vehicle communication system according to the embodiment of the present disclosure.

Referring to FIG. 8, first, when a predetermined event that triggers a network setting change occurs, the relay device 101A starts the network setting change (step S21).

Next, the relay device 101A transmits an information request notification to each of in-vehicle ECUs 202 and the relay devices 101B (steps S22, S23, and S24).

Next, each in-vehicle ECU 202 and the relay device 101B receive the information request notification and transmit the device information to the relay device 101A (steps S25, S26, and S27).

Next, the relay device 101A determines a target relay device by, for example, generating setting information, based on the received device information and the device information of the relay device 101A (step S28).

Next, the relay device 101A determines the importance level of the frame to be relayed by the target relay device, and determines that the importance level is “important”, for example (step S29).

Next, the relay device 101A transmits a transmission state query to the in-vehicle ECU 202 of the control system (step S30).

Next, the vehicle-mounted ECU 202 of the control system receives the transmission state query, and transmits, to the relay device 101A, for example, a transmission state response indicating that the message M1 is not being transmitted (step S31).

Next, the relay device 101A receives the transmission state response, determines that the setting change of the target relay device is “executable” (step S32), and notifies, for example, the setting unit 3 of the relay device 101A and the relay device 101B of the setting content (step S33).

Next, the setting unit 3 of the relay device 101A and the relay device 101B perform various kinds of setting change according to the setting contents notified from the relay device 101A (steps S34 and S35).

Next, the relay devices 101A and 101B and the functional units communicate with each other in accordance with the changed setting contents (step S36).

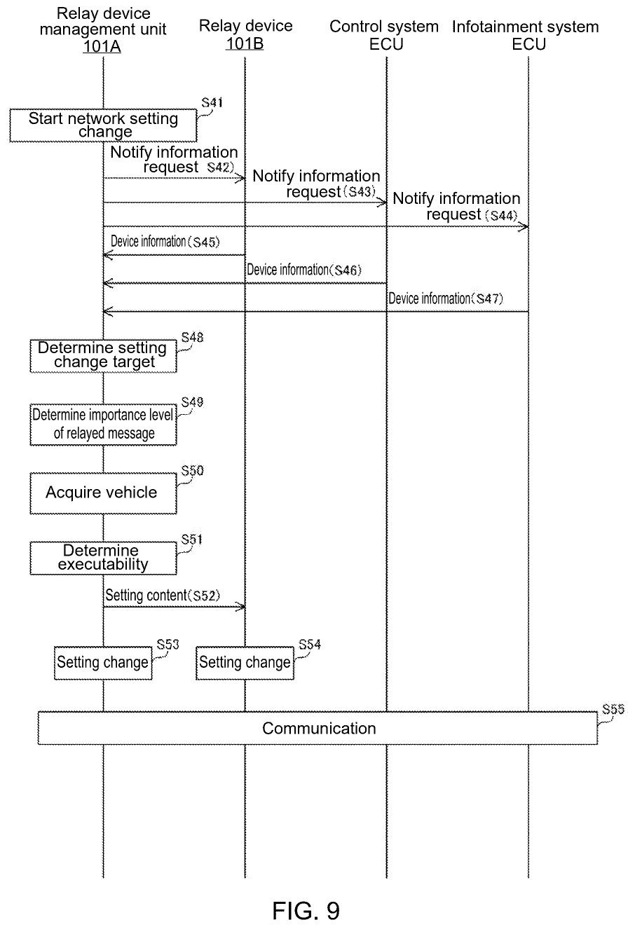

FIG. 9 is a diagram illustrating an example of a sequence of a network setting change in the in-vehicle communication system according to the embodiment of the present disclosure.

Referring to FIG. 9, the processing from steps S41 to step S49 is the same as the processing from steps S21 to step S29 in FIG. 8.

Next, the relay device 101A acquires, for example, the vehicle state information indicating that the vehicle 501 is stopped as the information on the state of the vehicle 501 (step S50).

Next, the relay device 101A determines that the setting change of the target relay device is “executable” (step S51), and notifies, for example, the setting unit 3 of the relay device 101A and the relay device 101B of the setting content (step S52).

Next, the setting unit 3 of the relay device 101A and the relay device 101B perform various setting changes according to the setting contents notified from the relay device 101A (steps S53 and S54).

Next, the relay devices 101A and 101B and the functional units communicate with each other in accordance with the changed setting contents (step S55).

Note that the in-vehicle communication system 301 may include one relay device 101A and not include the relay device 101B. In this case, since the execution determination unit 5 in the relay device 101A is fixedly notified of the determination result “important” from the importance determination unit 4, the execution determination unit 5 notifies the generating unit 2 that the setting change of the relay device 101A which is the target relay device is “executable” or “not executable” in accordance with the relay state notified from the relay state determination unit 6.

The management device according to the embodiment of the present disclosure is configured to be included in the relay device 101A in the in-vehicle communication system 301, but is not limited thereto. Some or all of the units other than the relay unit 1 in the relay device 101A may be included in a device other than the relay device 101A in the in-vehicle communication system 301, or may be provided outside the in-vehicle communication system 301.

In addition, the management device according to the embodiment of the present disclosure may be realized by a server (not shown) capable of communicating with the in-vehicle communication system 301. In this case, some or all of the functions of the management device according to the embodiment of the present disclosure may be provided by cloud computing. That is, the management device according to the embodiment of the present disclosure may be configured by a plurality of cloud servers or the like.

Each process (each function) of the above-described embodiments is realized by processing a processing circuit including one or more processors. The processing circuit may include, in addition to the one or more processors, one or more memories, an integrated circuit in which various analog circuits and various digital circuits are combined, and the like. The one or more memories store a program (instructions) that causes the one or more processors to execute the processes. The one or more processors may execute the processes in accordance with the program read from the one or more memories, or may execute the processes in accordance with a logic circuit designed in advance to execute the processes. The processor may be various processors suitable for control of a computer, such as a central processing unit (CPU), a graphics processing unit (GPU), a digital signal processor (DSP), a field programmable gate array (FPGA), and an application specific integrated circuit (ASIC). Note that the plurality of physically separated processors may execute the processes in cooperation with each other. For example, the processors mounted in a plurality of physically separated computers may execute the processes in cooperation with each other via a network such as a local area network (LAN), a wide area network (WAN), or the Internet. The program may be installed in the memory from an external server device or the like via the network, or may be distributed in a state of being stored in a recording medium such as a compact disc read only memory (CD-ROM), a digital versatile disk read only memory (DVD-ROM), or a semiconductor essential memory, and installed in the memory from the recording medium.

The above-described embodiments are intended to be considered as examples in all respects and not restrictive. The scope of the present disclosure is indicated by the scope of the claims rather than the meaning described above, and is intended to include all changes within the meaning and scope equivalent to the scope of the claims.

The above-described description includes the following features.

### Appendix 1

A management device for use in an in-vehicle network installed in a vehicle, comprising: an importance level determination unit configured to determine an importance level of a frame to be relayed by a relay device that performs relay processing for relaying a frame transmitted and received between a plurality of functional units in the in-vehicle network and is a target of a setting change, and an executability determination unit configured to determine whether or not to perform the setting change based on a determination result of the importance level determination unit, and the management device further comprising: a relay state determination unit configured to determines whether the relay device in the in-vehicle network is in a first relay state in which the relay device relays a frame of a specific importance level or in a second relay state in which the relay device does not relay a frame of the specific importance level, wherein the executability determination unit determines whether or not to perform the setting change, based on a determination result of the importance level determination unit and a determination result of the relay state determination unit, and the executability determination unit determines that the setting change is not to be performed in a case where a frame to be relayed by a relay device that is a target of the setting change is a frame of the specific importance level and the relay state determination unit determines that the relay device is in the first relay state, and determines that the setting change is to be performed in a case where the relay device is in the second relay state.

### Appendix 2

A management device used in an in-vehicle network mounted in a vehicle, the management device comprising: a processing circuit, and the processing circuit is configured to determine an importance level of a frame to be relayed by a relay device that performs relay processing for relaying a frame transmitted and received between a plurality of functional units in the in-vehicle network and is a target of a setting change, and determines whether or not to perform the setting change based on a determination result.

1. A management device for use in an in-vehicle network installed in a vehicle, the management device comprising:
an importance level determination circuitry configured to determine an importance level of a frame to be relayed by a relay device that performs relay processing for relaying a frame transmitted and received between a plurality of functional circuitry in the in-vehicle network and is a target of setting change; and
an executability determination circuitry configured to determine whether or not to perform the setting change, based on a determination result of the importance level determination circuitry.

2. The management device according to claim 1, further including;
a generation unit configured to generate setting information of a new network, based on device information acquired from the plurality of functional circuitry, and thereby determine the relay device to be a target of a setting change for performing communication in the new network, and notifying the determined relay device of a setting content,
wherein, when the executability determination circuitry determines not to perform the setting change of at least one of the plurality of relay devices, the generation circuitry does not notify the at least one of the plurality of relay devices of the setting content.

3. The management apparatus according to claim 1, further including;
a storage circuitry configured to store correspondence information indicating a correspondence relationship between identification information of the relay device and an importance level of a frame to be relayed by the relay device,
wherein the importance level determination circuitry determines the importance level based on the correspondence information.

4. The management device according to claim 1, further including;
a relay state determination circuitry configured to determine whether or not the relay device in the in-vehicle network is in a state of relaying a frame of a specific importance level,
wherein the executability determination circuitry determines whether or not to perform the setting change, based on a determination result of the importance level determination circuitry and a determination result of the relay state determination circuitry.

5. The management device according to claim 4, further including;
a vehicle state acquisition circuitry configured to acquire vehicle state information related to a state of the vehicle,
wherein the relay state determination circuitry determines whether or not the relay device in the in-vehicle network is in a state of relaying a frame of the specific importance level, based on the vehicle state information acquired by the vehicle state acquisition circuitry.

6. The management device according to claim 4, wherein the relay state determination circuitry makes an inquiry to a specific functional circuitry as to whether or not the frame of the specific importance level is being transmitted.

7. The management apparatus according to claim 1, further including;
a device information acquisition circuitry configured to acquire device information of the functional circuitries,
wherein the importance level determination circuitry determines the importance level, based on the device information acquired by the device information acquisition circuitry.

8. A vehicle communication management method in a management device for use in an in-vehicle network installed in a vehicle, the vehicle communication management method comprising:
a step of determining an importance level of a frame to be relayed by a relay device that performs relay processing for relaying a frame transmitted and received between a plurality of functional circuitries in the in-vehicle network and is a target of a setting change; and
a step of determining whether or not to perform the setting change, based on a determination result of the importance level.

9. A non-transitory computer-readable storage medium storing a vehicle communication management program to be used in a management device for use in an in-vehicle network installed in a vehicle, the vehicle communication management program causing a computer to function as:
an importance level determination circuitry configured to determine an importance level of a frame to be relayed by a relay device that performs relay processing relaying a frame transmitted and received between a plurality of functional circuitries in the in-vehicle network and is a target of a setting change; and
an executability determination circuitry configured to determine whether or not to perform the setting change, based on a determination result of the importance level determination circuitry.

10. The management apparatus according to claim 2, further including;
a storage circuitry configured to store correspondence information indicating a correspondence relationship between identification information of the relay device and an importance level of a frame to be relayed by the relay device,
wherein the importance level determination circuitry determines the importance level based on the correspondence information.

11. The management device according to claim 2, further including;
a relay state determination circuitry configured to determine whether or not the relay device in the in-vehicle network is in a state of relaying a frame of a specific importance level,
wherein the executability determination circuitry determines whether or not to perform the setting change, based on a determination result of the importance level determination circuitry and a determination result of the relay state determination circuitry.

12. The management device according to claim 3, further including;
a relay state determination circuitry configured to determine whether or not the relay device in the in-vehicle network is in a state of relaying a frame of a specific importance level,
wherein the executability determination circuitry determines whether or not to perform the setting change, based on a determination result of the importance level determination circuitry and a determination result of the relay state determination circuitry.

13. The management apparatus according to claim 2, further including;
a device information acquisition circuitry configured to acquire device information of the functional circuitries,
wherein the importance level determination circuitry determines the importance level, based on the device information acquired by the device information acquisition circuitry.

14. The management apparatus according to claim 3, further including;
a device information acquisition circuitry configured to acquire device information of the functional circuitries,
wherein the importance level determination circuitry determines the importance level, based on the device information acquired by the device information acquisition circuitry.

15. The management apparatus according to claim 4, further including;
a device information acquisition circuitry configured to acquire device information of the functional circuitries,
wherein the importance level determination circuitry determines the importance level, based on the device information acquired by the device information acquisition circuitry.

16. The management apparatus according to claim 5, further including;
a device information acquisition circuitry configured to acquire device information of the functional circuitries,
wherein the importance level determination circuitry determines the importance level, based on the device information acquired by the device information acquisition circuitry.

17. The management apparatus according to claim 6, further including;
a device information acquisition circuitry configured to acquire device information of the functional circuitries,
wherein the importance level determination circuitry determines the importance level, based on the device information acquired by the device information acquisition circuitry.
